(19) United States
(12) Patent Application Publication
(10) Pub. No.: US 2024/0223463 A1
(43) Pub. Date: Jul. 4, 2024

(54) Method and System for Analysis of Hardware Infrastructure Deployment

(71) Applicant: Dell Products L.P., Round Rock, TX (US)

(72) Inventors: Vinay Sawal, Fremont, CA (US); Sithiqu Shahul Hameed, Chennai (IN); Udhaya Chandran Shanmugam, Santa Clara, CA (US)

(73) Assignee: Dell Products L.P., Round Rock, TX (US)

(21) Appl. No.: 18/091,979

(22) Filed: Dec. 30, 2022

(51) Int. Cl. H04L 41/14

(52) U.S. Cl. CPC H04L 41/145

(57) ABSTRACT

Described herein are methods and a system for deployment recommendation of a hardware infrastructure configurations at a customer site. A fabric diagram that represents the hardware infrastructure is converted to a multigraph. Augmented and feature matrices are created the multigraph; deriving feature matrix, and processed by a multi-layer graph convolution network (GCN) to determine a predicted score for the hardware infrastructure.

### BACKGROUND OF THE INVENTION

### Field of the Invention

The present invention relates to analyzing hardware infrastructure prior to deployment at customer sites. More specifically, embodiments of the invention provide for analyzing connectivity of various configurations of hardware infrastructures used at customer site networks.

### Description of the Related Art

In certain cases, an entity, such as a customer of devices or components that are installed in infrastructures at a customer site, desires to upgrade and/or install hardware racks of devices or components that support computing, networking, storage, management, etc. These upgraded or new hardware racks are connected to a network or networks at the customer site. Such networks include switching components that have certain capabilities, such as computing, bandwidth, etc. which can differ. The combination of the hardware racks and networks can be considered as a hardware infrastructure.

Before hardware racks are installed or upgraded, a determination is made as to the capability and compatibility of a customer's network(s) to be integrated with the installed or upgraded hardware racks. In particular, the determination is directed if the switching components of the network(s) and switching components of the hardware racks are compatibility and are capable of supporting the new or upgraded hardware racks.

The determination of compatibility and capability typically can involve a tedious manual process of examining wiring diagrams, determining components (e.g., switching components) and their capabilities (e.g., computing, bandwidth limitation). This manual process is performed at the customer network(s) and for the new and upgraded hardware racks.

Such manual processes can be time consuming and prone to errors. Identifying the wrong or unacceptable components can lead to latent problems when activating the hardware rack.

### SUMMARY OF THE INVENTION

A computer-implementable method, system and computer-readable storage medium for deployment recommendation of a hardware infrastructure configurations at a customer site comprising converting a fabric diagram representing the hardware infrastructure is converted to a multigraph; creating an augmented matrix, A, from the multigraph; deriving feature matrix, X, from the multigraph; using a multi-layer graph convolution network (GCN), processing augmented matrix, A, and feature matrix, X, to determine a predicted score for the hardware infrastructure; and providing a recommendation based on a minimal acceptable score.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 is a system as implemented in the present invention;

FIG. 3 illustrates a fabric diagram of a spine-leaf architecture of a hardware infrastructure;

FIG. 4 illustrates an undirected multigraph representing spine-leaf connections

FIG. 5 illustrates an adjacency matrix;

FIG. 6 illustrates an augmented adjacency matrix;

FIG. 7 illustrates a degree matrix;

FIG. 8 illustrates a normalized adjacency matrix;

FIG. 9 illustrates node/vertex feature vectors;

FIG. 10 illustrates node/vertex matrix;

FIG. 11 illustrates the use of a graph convolution network (GCN);

FIG. 12 illustrates a predicted score as function of multigraph, and example input and score values; and

FIG. 13 is a generalized flowchart analyzing connectivity of various configurations of hardware infrastructures used at customer site networks.

### DETAILED DESCRIPTION

Implementations described herein provide for use of a fabric (i.e., infrastructure architecture) analysis algorithm using a Graph Convolution Network (GCN) to generate real-valued scores used to assess the robustness of the various design implementations of network(s) with hardware rack(s) (i.e., hardware infrastructure). Based on the score, a qualitative determination can be made as to deployment and use of new or upgraded hardware racks with customer networks.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

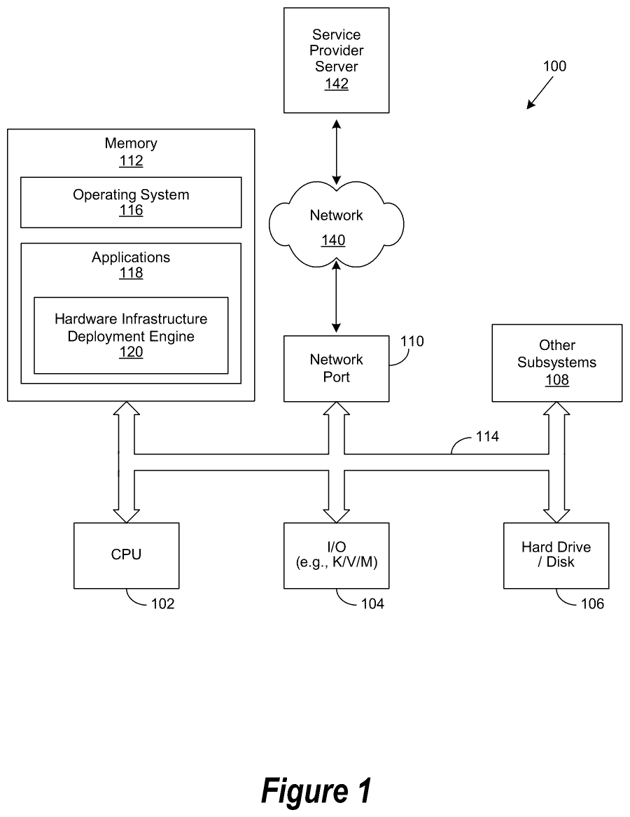

FIG. 1 is a generalized illustration of an information handling system (IHS) 100 that can be used to implement the system and method of the present invention. The information handling system (IHS) 100 includes a processor (e.g., central processor unit or “CPU”) 102, input/output (I/O) devices 104, such as a microphone, a keyboard, a video display or display device, a mouse, and associated controllers (e.g., K/V/M), a hard drive or disk storage 106, and various other subsystems 108.

In various embodiments, the information handling system (IHS) 100 also includes network port 110 operable to connect to a network 140, where network 140 can include one or more wired and wireless networks, including the Internet. Network 140 is likewise accessible by a service provider server 142.

The information handling system (IHS) 100 likewise includes system memory 112, which is interconnected to the foregoing via one or more buses 114. System memory 112 can be implemented as hardware, firmware, software, or a combination of such. System memory 112 further includes an operating system (OS) 116 and applications 118.

Implementations provide for applications 118 to include a hardware infrastructure deployment engine 120. The hardware infrastructure deployment engine 120 implements a graph convolution network (GCN) as further described herein, used on multigraph representation of an infrastructure architecture or fabric of the hardware infrastructure. The hardware infrastructure includes hardware racks and networks. Various known existing (organic) and synthetic data values can be entered into the multigraph to determine results of various implementations. A determination can be as to particular implementations that meet a satisfactory outcome.

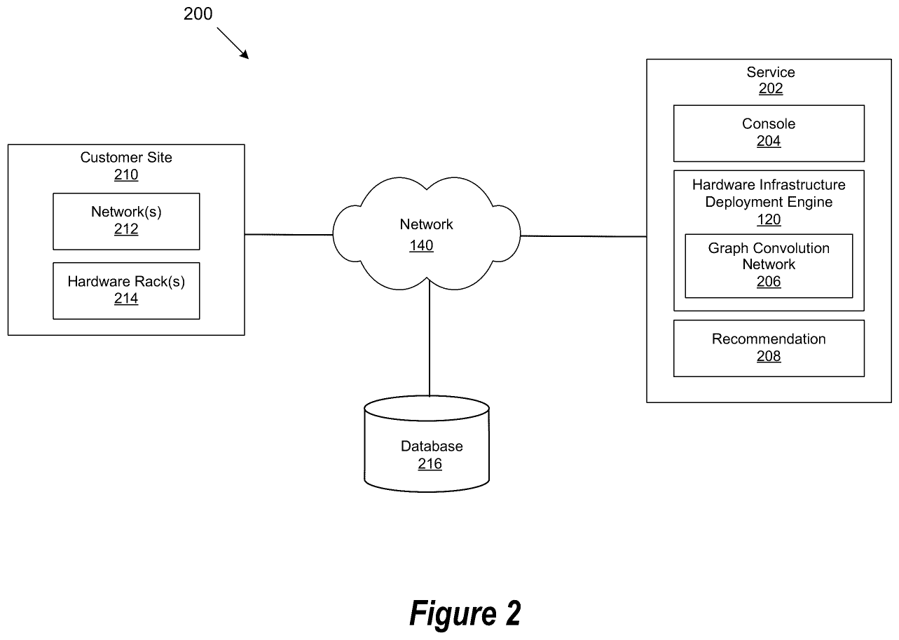

FIG. 2 shows a system 200 that supports the processes described herein. Various implementations provide for the system 200 to include a service 202. The service 202 can be implemented as a cloud computing, one or more physical computing devices (e.g., servers), etc. Implementations provide for the service to include one or more information handling system (IHS) 100 described above. Implementations provide for the service 202 to be accessible as website.

The service 202 can be implemented with a console 204 to allow a user to communicate with the service 202, allowing the user to enter or select values or inputs (e.g., data), and to receive output (e.g., recommendations, results) from the service 202.

Implementations provide for the service 202 to include the hardware infrastructure deployment engine 120 described above, where the hardware infrastructure deployment engine 120 includes graph convolution network (GCN) 206. The GCN 206 is further described herein.

The service 202 further can include a recommendation component 208. The recommendation component 208 can be configured to provide the results generated by the hardware infrastructure deployment engine 120. For example, if a customer desires to use service 202 for the deployment of hardware racks, the hardware infrastructure deployment engine 120 can run various implementations of hardware infrastructure and provide the results to the customer through recommendation component 208.

The service 202 is connected to network 140. As described above, network 140 can include one or more wired and wireless networks, including the Internet. Network 140 connects service 202 to a customer site 210. The customer site 210 includes customer network(s) 212, and existing upgradeable and/or potentially new hardware rack(s) 214. Hardware rack(s) 214 support components directed to computing, networking, storage, management, etc., including a combination thereof.

The combination of the network(s) 212 and hardware racks(s) 214 are considered as a hardware infrastructure as further described herein. The network(s) 212 and hardware racks(s) 214 are interconnected through switching components included in network(s) 212 and hardware racks(s) 214, where such switching components have certain capabilities and compatibilities, including computing, bandwidth limitation, communication standards support, etc. It is desirable to assure that any upgraded or new hardware rack(s) 214 that is/are integrated with network(s) 212 be supported with adequate (i.e., capable) and compatible switching components. As described herein, the hardware infrastructure deployment engine 120 is configured to provide such determination and recommendation.

The system 200 further can include a database 216. The database 216 can include data as to the switching components, including device identification (e.g., model number), performance capability (e.g., computing, bandwidth, etc.), standards compatibility, etc. The database 216 can include known existing (organic) and synthetic (e.g., derived from known) data values. The database 216 can be accessed by service, 202 where the data is consumed by the hardware infrastructure deployment engine 120.

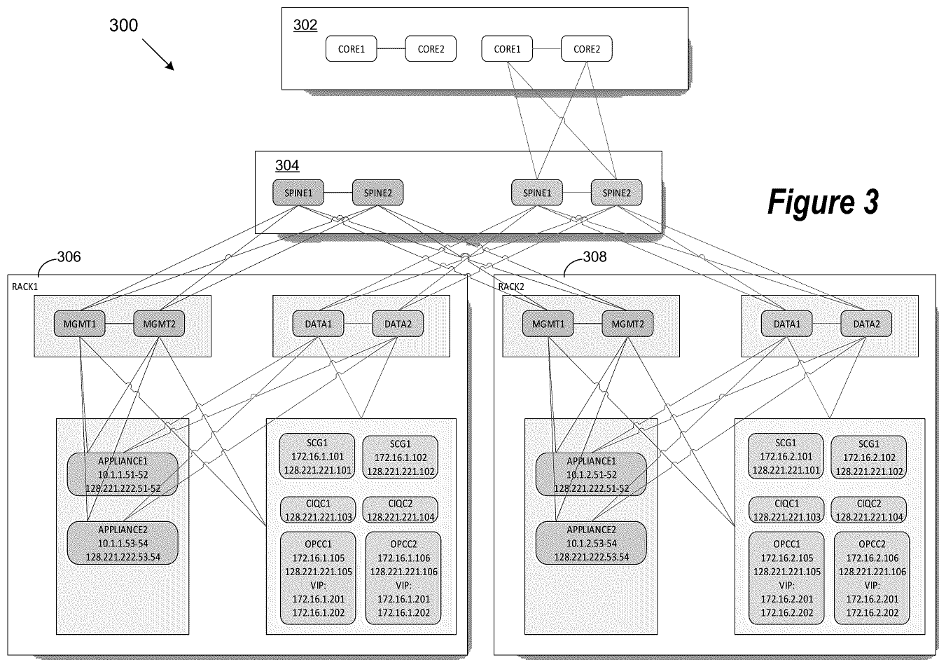

FIG. 3 shows a fabric diagram of a hardware infrastructure 300. The hardware infrastructure 300 is represented as a spine-leaf architecture. Generally, a spine-leaf architecture is a data center network topology that includes two switching layers, a spine layer and leaf layer. A leaf layer includes access switches that aggregate traffic from components and connect directly into a spine or network core. Spine switches interconnect all leaf switches in a full-mesh topology. Every leaf switch in a spine-leaf architecture connects to every switch in the network fabric.

In this example, 302 includes the cores of a network, which are connected to spines 304. Spines 304 are connected to rack1 306 and rack2 308. Rack1 306 and rack2 308 include leaves, as represented MGMT1, MGMT2, DATA1, DATA2 of Rack1 306, and MGMT1, MGMT2, DATA1, DATA2 of Rack2 308.

The leaves of rack1 306 and rack2 308 connect to components and are represented APPLIANCE1, APPLIANCE2, SCG1, SCG2, CIQC1, CIQC2, OPCC1, OPCC2 of rack1 306, and APPLIANCE1, APPLIANCE2, SCG1, SCG2, CIQC1, CIQC2, OPCC1, OPCC2 of rack2 308.

The spines 304 of the network and leaves of rack1 306 and rack2 308 are given particular known or potential data values representing capability and compatibility. With different implementations (e.g., different values), an analysis of connectivity performance can be performed.

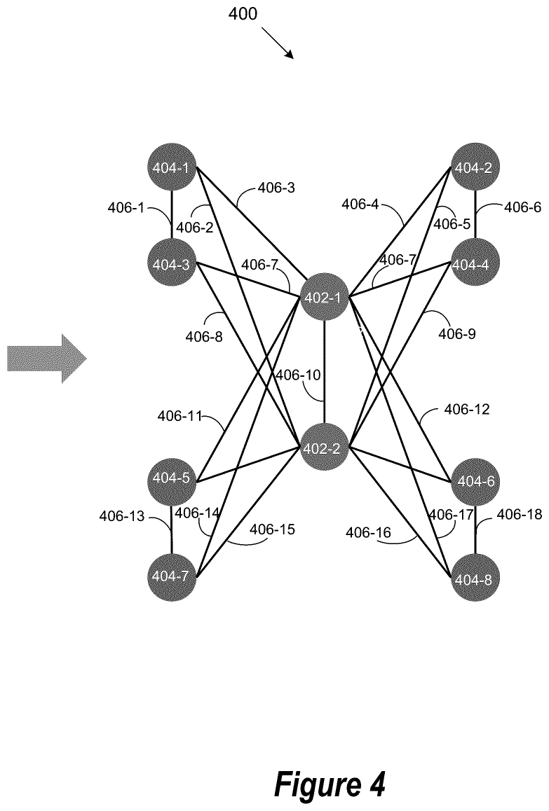

FIG. 4 shows an undirected multigraph 400 representing spine-leaf connections. A fabric diagram such as hardware infrastructure 300 with spine-leaf architecture is converted into an undirected (i.e., multiple connections) multigraph, such as undirected multigraph 400. In this example, the spines are represented as nodes 402-1 and 402-1, and the leaves are represented as nodes 404-1 to 404-8. Connections 406 between spines and leaves are considered as edges. The nodes 402 and 404 are considered as vectors having vector embeddings from which feature extraction can be performed. For example, features being the compatibly and capability of the nodes 402 and 404 (i.e., spines and leaves).

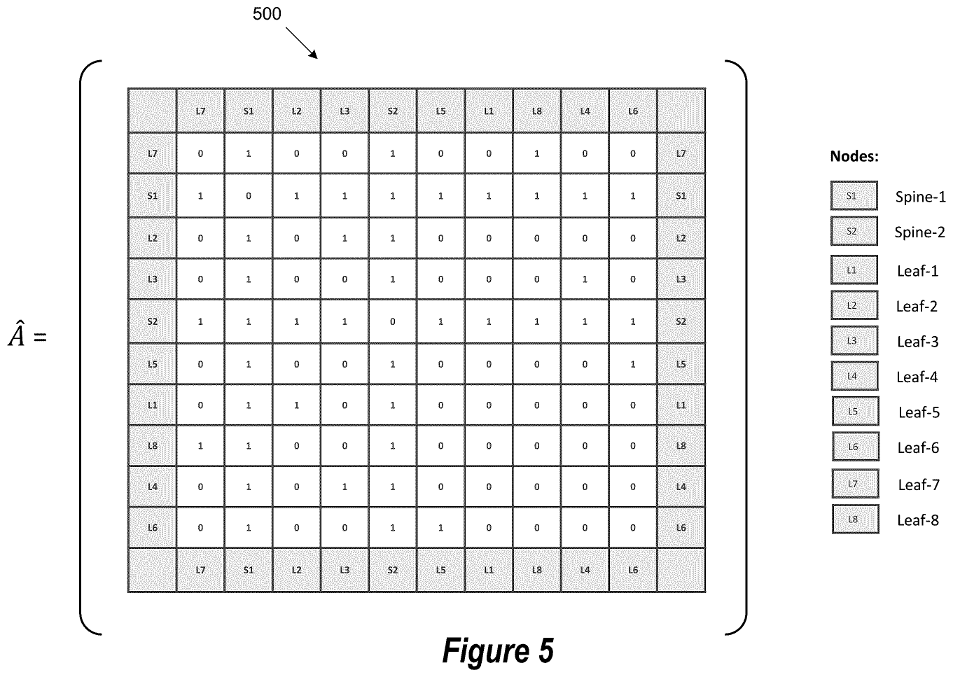

FIG. 5 shows an adjacency matrix 500. The adjacency matrix 500 represents the multigraph 400 of FIG. 4. The conversion of multigraph 400 into an adjacency matrix 500 allows for mathematical calculation on a two-dimensional matrix.

The adjacency matrix 500 can be designated as Â, and defined by the following equation:

$$\hat{A} ∈ {ℝ}^{n \times n}$$

Adjacency matrix 500 is an “n×n” matrix, where n is the number of nodes 402 and 408 (i.e., spines and leaves). Edges or connections between nodes are represented as either a value of “0” (no connection/edge), or “1” (connection/edge) between intersecting nodes 402 and 408 (i.e., spines and leaves).

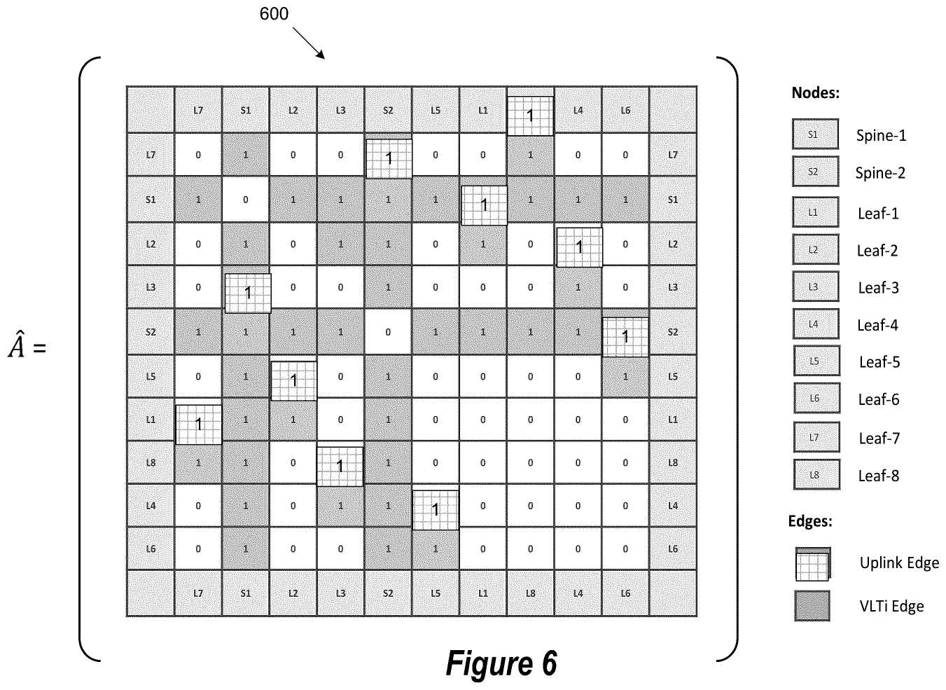

FIG. 6 shows an augmented adjacency matrix 600. The adjacency matrix 500 or Â can have particular edges or connections with specific features or properties. For example, an edge or connection can be an uplink edge or connection, or a VLT interface (VLTi) edge or connection. Such features or properties can be identified in Â or augmented adjacency matrix 600.

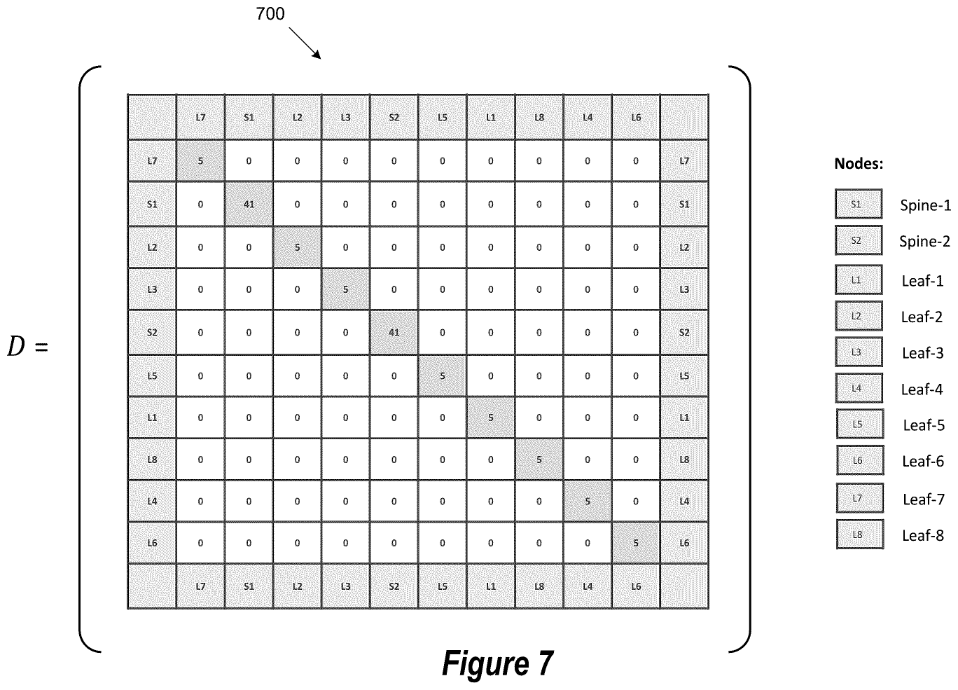

FIG. 7 shows degree or D matrix 700. The degree matrix 700 shows the number of incoming and outgoing connections (edges) that occur for a given node 402 and 408 (i.e., spines and leaves). For example, the degree of leaf 7 or L7 is 5 (five) connections or edges, and the degree of spine 1 or S1 is 41 connections or edges.

D is defined by the following equation:

$$D ∈ {ℝ}^{n \times n}$$

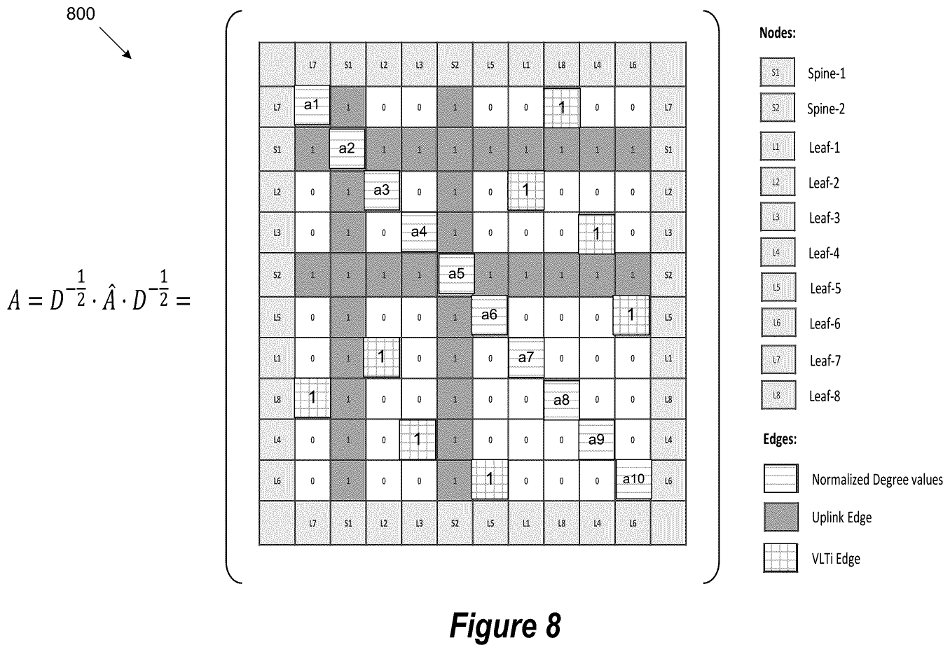

FIG. 8 shows a normalized adjacency matrix 800. In particular, the augmented adjacency matrix 600 represented as Â is normalized with degree matrix 700 or D. The normalized adjacency matrix 800 or A is defined by the following equation.

$$A = {D}^{- \frac{1}{2}} \cdot \hat{A} \cdot {D}^{\frac{1}{2}}$$

The normalized adjacency matrix 800 or A is a linear combination of different matrices to provide a single input for a graph convolution network (e.g., GCN 206) as further described herein.

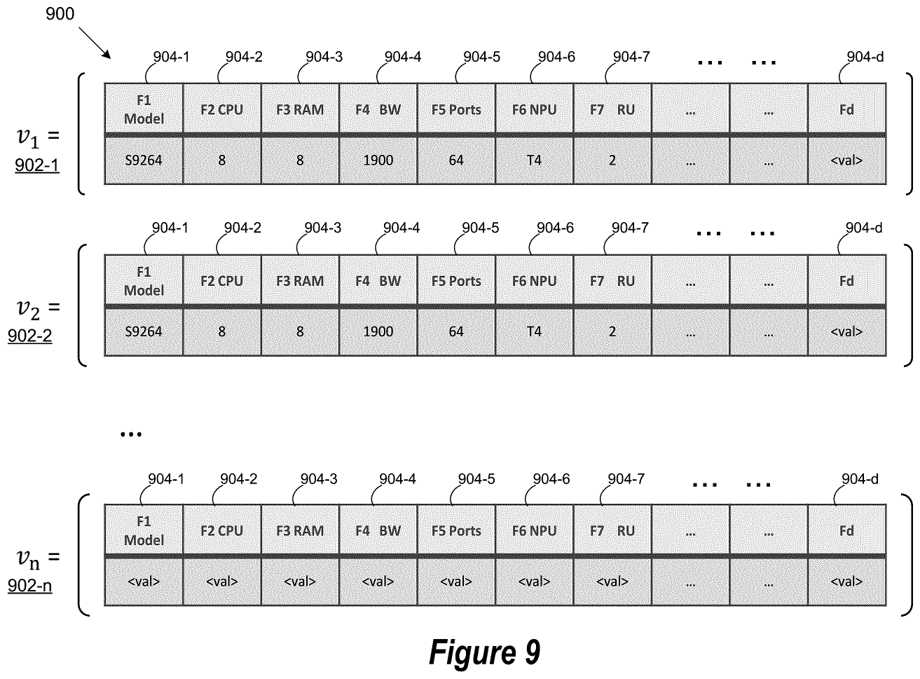

FIG. 9 shows a node/vertex feature vectors 900. As discussed, the spines and leaves have particular compatibility and capability features and properties. As represented by nodes or vectors, such features and properties are provided as vector embeddings. Feature extraction is performed to extract information as to particular nodes or vectors (e.g., spines, leaves). Information may be derived from known model specifications, etc. What unique characteristics does vector or node represent? Vectors 900 includes n number of vertices v₁ 902-1 to vₙ 902-n. In the example discussed above, there are two spines and eight leaves, for a total of ten vertices. Each vertex v 902 can have “d” number of unique attributes or features represented under headers F1 904-1 to Fd 904-d.

A node/vertex vector 900 can be defined by the equation:

$${v}_{i} ∈ {ℝ}^{1 \times d}$$

Implementations provide for the node/vertex vectors 900 to be converted from categorical (nominal, ordinal) representation to a numeric representation that can be mathematically processed. Implementations provide for label encoders, one-hot vector encoders to perform the conversion.

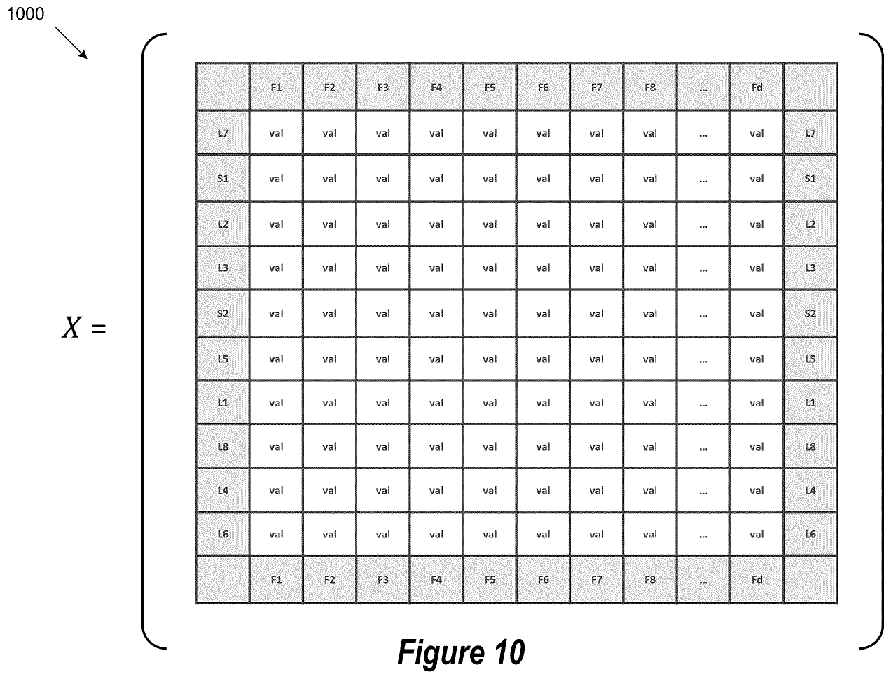

FIG. 10 shows node/vertex matrix 1000. The converted node/vertex vectors 900 are stacked or concatenated to derive the X or node/vertex matrix 1000. Nodes (e.g., spines and leaves) are aligned with features (e.g., F1 to Fd). The node/vertex matrix 1000 can be defined by the equation:

$$X ∈ {ℝ}^{n \times d}$$

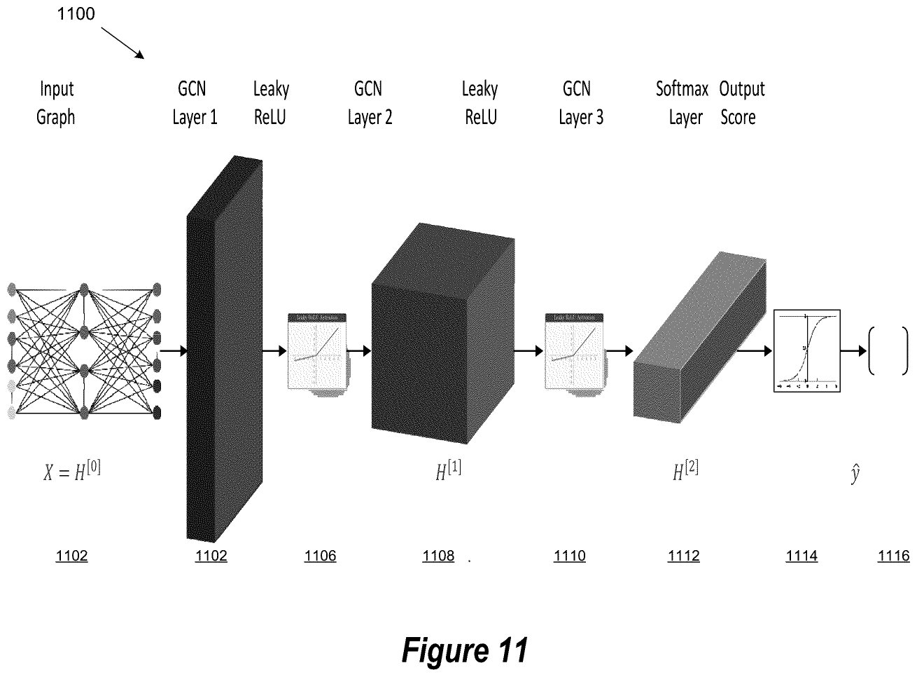

FIG. 11 shows the use of a graph convolution network (GCN), such as (GCN) 206, for analyzing connectivity of various configurations of hardware infrastructures used at customer site networks.

The GCN is a deep neural network that is used to validate strength/robustness of a network design prior to deployment. GCNs provide neural network architecture for machine learning on graphs. A GCN can implement one or more layers, as discussed herein. In this example, a three layer deep GCN is discussed. The GCN is employed, since a GCN can be faster and more [symbol] there can be millions of in a multi-graph wiring diagram.

GCNs are similar to convolutional neural networks, except GCNs have the ability to preserve the graph structure without overwhelming input data. GCNs utilize the concept of convolutions on graph by aggregating local neighborhood regional information using multiple filters/kernels to extract high level representations in a graph. Convolution filters for GCN can be based on Digital Signal Processing and Graph Signal Processing, and categorized in time and space dimensions. Spatial filter combines neighborhood sampling with degree of connectivity k. Spectral filters use Fourier transform and Eigen decomposition to aggregate node information.

As discussed, fabric diagram as shown in FIG. 3, is converted into an Undirected multigraph with unique identity edges as shown in FIG. 4. In this multigraph, devices (spines and leaves) can be considered as nodes/vertices in the fabric. Edges are link connections between the devices. There could be multiple edges (with unique attributes) between two nodes. Feature extractions are performed on nodes and edges. The GCN model can be trained using organic and synthetic data. The trained GCN model can be used for predicting the strength/quality of hardware infrastructure wiring diagram prior to deployment.

As discussed above, the feature vectors of FIG. 9 and stacked to create feature matrix 1000. Nodes (e.g., spines and leaves) are aligned with features (e.g., F1 to Fd). The “n×d” dimension feature matrix 1000 defined by the equation:

$$X ∈ {ℝ}^{n \times d}$$

The feature matrix 1000 and normalized adjacency matrix 800 are fed to the GCN layers for processing.

1102 represents an input graph, and X=H^{[0]}. The Feature Matrix X is fed as an input to the GCN: X=H^{[0]} or H^{[0]}=x

A GCN layer performs convolutions on the input using predefined filters and generates an output with a dimension different from that of the input based on the following equation:

$${H}^{[ 1 ]} = σ ( A \cdot {H}^{[ 0 ]} \cdot {W}^{[ 0 ]} + {b}^{[ 0 ]} )$$

where:
H^{[l]} is Hidden layer output of layer-1
A is Normalized Multigraph Adjacency Matrix
W^{[l]} is Weight Matrix at layer-1 (Model parameter)
b^{[l]} is Bias term at layer-1 (Model parameter)
σ is Non-linear function (Leaky-ReLU)

1104 represents GCN layer 1 with σ or Leaky-ReLU. 1106 represents the output from GCN layer 1. 1108 represents GCN layer 1 with σ or Leaky-ReLU. 1110 represents the output from GCN layer 2. 1112 GCN layer 3. After flowing through multiple GCN layers with different convolution filters, the hidden layer output 1114 of last layer (i.e., layer 3) is fed to a softmax non-linear function that produces a probability distribution of possible score values summing to 1. This is the predicted score 1116, as represented by the equation:

$$\hat{y} = softmax ( {H}^{[ l ]}$$

where:
H^{[l]} is Hidden layer output of final layer
ŷ is a Predicted score
softmax is a non-linear function (Softmax)

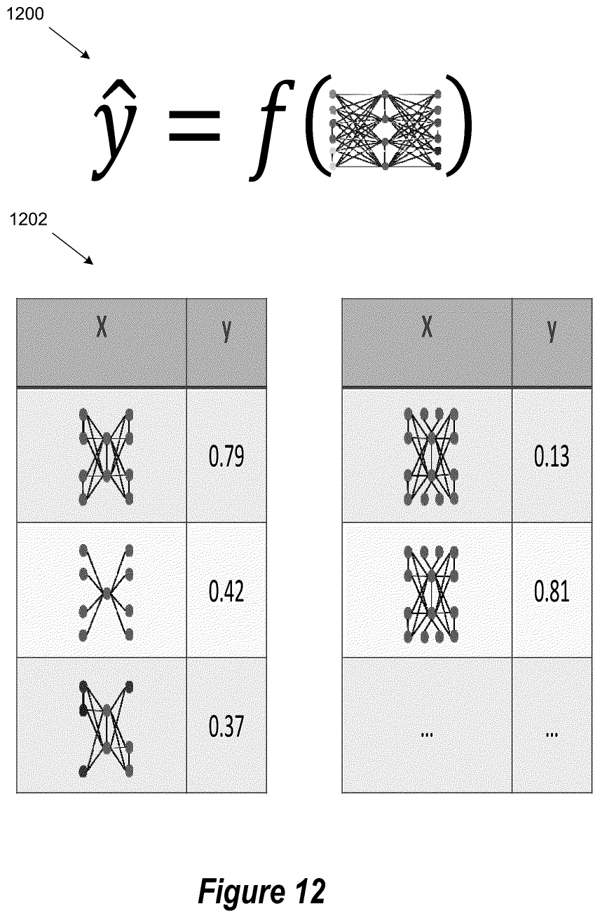

FIG. 12 shows a predicted score as function of multigraph, and example input and score values. 1202 represents ŷ as a function of a multigraph representation of an infrastructure architecture or fabric of the hardware infrastructure as described herein. 1204 represents various multigraphs and their results after processing by the GCN. Results can range from 0 to 1, where 1 is the best score. In determining acceptable infrastructure configurations, a threshold can be set. For example, any result higher than 0.75 is acceptable.

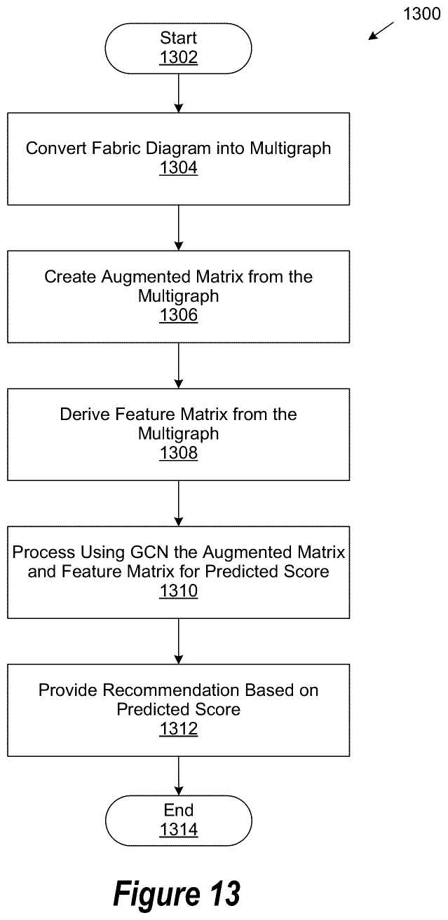

FIG. 13 shows a generalized flowchart for analyzing connectivity of various configurations of hardware infrastructures used at customer site networks. Implementations provide for the steps of process 1300 to be performed by the service 202. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 1302, the process 1300 starts. At step 1304, a fabric diagram is converted to a multigraph. The fabric diagram being a wiring diagram that represents switching connection from a customer network(s) to hardware racks to be upgraded or newly installed with the customer network(s). The fabric diagram is shown above in FIG. 3 and the multigraph in FIG. 4.

At step 1306, an augmented matrix A is created from the multigraph. The augmented matrix A is shown above in FIG. 8. FIGS. 5 to 7 and their description show how the augmented matrix A is created.

At step 1308, a feature matrix X is derived from the multigraph. The feature matrix X is shown in FIG. 10, where features vectors used to create the feature matrix X is shown in FIG. 9.

At 1310, using a graph convolution network (GCN), the augmented matrix A and feature matrix X are processed to arrive at a predicted score for hardware infrastructure. FIG. 11 shows the process that the GCN is used.

At step 1312, the deployment recommendation is performed. The recommendation component 208 can provide a recommendation based on minimal acceptance scores. At step 1314, the process 1300 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for generalized flowchart for deployment recommendation of a hardware infrastructure configurations at a customer site comprising:
converting a fabric diagram representing the hardware infrastructure is converted to a multigraph;
creating an augmented matrix, A, from the multigraph;
deriving feature matrix, X, from the multigraph;
using a multi-layer graph convolution network (GCN), processing augmented matrix, A, and feature matrix, X, to determine a predicted score for the hardware infrastructure; and
providing a recommendation based on a minimal acceptable score.

2. The computer-implementable method of claim 1, wherein the fabric diagram is a spine leaf architecture.

3. The computer-implementable method of claim 1, wherein switching components having particular features are represented in the multigraph.

4. The computer-implementable method of claim 1, wherein the augmented matrix, A, is created based on degree of connectivity and functionality of nodes of the multigraph.

5. The computer-implementable method of claim 1, wherein the feature matrix, X, includes feature vectors.

6. The computer-implementable method of claim 1, wherein the multi-layer graph convolution network (GCN) is three layers.

7. The computer-implementable method of claim 1, wherein the minimal acceptable score is predetermined.

8. A system comprising:
a plurality of processing systems communicably coupled through a network, wherein the processing systems include non-transitory, computer-readable storage medium embodying computer program code interacting with a plurality of computer operations for deployment recommendation of a hardware infrastructure configurations at a customer site comprising:
converting a fabric diagram representing the hardware infrastructure is converted to a multigraph;
creating an augmented matrix, A, from the multigraph;
deriving feature matrix, X, from the multigraph;
using a multi-layer graph convolution network (GCN), processing augmented matrix, A, and feature matrix, X, to determine a predicted score for the hardware infrastructure; and
providing a recommendation based on a minimal acceptable score.

9. The system of claim 8, wherein the fabric diagram is a spine leaf architecture.

10. The system of claim 8, wherein switching components having particular features are represented in the multigraph.

11. The system of claim 8, wherein the augmented matrix, A, is created based on degree of connectivity and functionality of nodes of the multigraph.

12. The system of claim 8, wherein the feature matrix, X, includes feature vectors.

13. The system of claim 8, wherein the multi-layer graph convolution network (GCN) is three layers.

14. The system of claim 8, wherein the minimal acceptable score is predetermined.

15. A non-transitory, computer-readable storage medium embodying computer program code for deployment recommendation of a hardware infrastructure configurations at a customer site, the computer program code comprising computer executable instructions configured for:
converting a fabric diagram representing the hardware infrastructure is converted to a multigraph;
creating an augmented matrix, A, from the multigraph;
deriving feature matrix, X, from the multigraph;
using a multi-layer graph convolution network (GCN), processing augmented matrix, A, and feature matrix, X, to determine a predicted score for the hardware infrastructure; and
providing a recommendation based on a minimal acceptable score.

16. The non-transitory, computer-readable storage medium of claim 15, wherein the fabric diagram is a spine leaf architecture.

17. The non-transitory, computer-readable storage medium of claim 15, wherein switching components having particular features are represented in the multigraph.

18. The non-transitory, computer-readable storage medium of claim 15, wherein the augmented matrix, A, is created based on degree of connectivity and functionality of nodes of the multigraph.

19. The non-transitory, computer-readable storage medium of claim 15, wherein the feature matrix, X, includes feature vectors.

20. The non-transitory, computer-readable storage medium of claim 15, wherein the multi-layer graph convolution network (GCN) is three layers.
